(19) United States
(12) Patent Application Publication
(10) Pub. No.: US 2019/0344166 A1
(43) Pub. Date: Nov. 14, 2019

(54) ADDITIONAL CONTROLLER OF GAME CONTROLLER

(71) Applicant: Cheng Uei Precision Industry Co., Ltd., New Taipe City (TW)

(72) Inventors: Hsieh Cheng Chou, New Taipei City (TW); Chi Ming Tseng, New Taipei City (TW)

(21) Appl. No.: 16/140,584

(22) Filed: Sep. 25, 2018

(30) Foreign Application Priority Data
May 10, 2018 (TW) 107206129

(51) Int. Cl. A63F 13/24; A63F 13/98

(52) U.S. Cl. CPC A63F 13/24; A63F 13/98

(57) ABSTRACT

The present invention is an additional controller of game controller, the additional controller comprises a support arm, a contact portion, an actuating portion and at least one fixing portion. The support arm comprises a first end and a second end, wherein the contact portion is disposed on an outer side of the first end, the actuating portion is disposed on an inner side of the first end. The fixing portion is connected to the second end of the support arm, wherein the fixing portion is able to be mounted on a housing of the game controller by using a tool. When the contact portion is applied a force, the support arm is driven to be deformed and the actuating portion activates a switch which is disposed inside the housing of the game controller and is located under a guiding hole of the housing. When the contact portion is not applied a force, the actuating portion passes though the guiding hole.

### BACKGROUND OF THE INVENTION

### 1. Field of the Invention

The present invention generally relates to an additional controller of a game controller, more particularly, the additional controller is capable of being disassembled from the game controller or being assembled to the game controller.

### 2. The Related Art

Throughout the development of the video game industry, a game controller is the most indispensable part for a game console. The user can control the role in the game to complete the mission by using the game controller. Therefore, in addition to gaming skill of the user, how to design a game controller which gives the user perfect fit is one of dedicated researches in the game industry.

At present, most of game controllers are designed to operate with both hands. Some of conventional hand-held game controllers include different function switches to provide the user for playing game, such like action buttons, directional gamepad, thumbsticks, multifunction triggers, bumper buttons and/or paddles. Specifically, the action buttons, directional gamepad and thumbsticks are disposed in a top of the game controller, these function switches usually are operated by the user's thumbs. The multifunction triggers and the bumper buttons are disposed in a front of the game controller, these function switches usually are operated by the user's index fingers. And the paddles are disposed in a bottom of the game controller, these function switches usually are operated by the user's middle finger or ring finger.

With the rise of the electronic sport, it also promotes rapidly the gaming market. The game controller has more diversified control function, however, every user has different controlling habit when he operates the game controller. Therefore, an additional controller for a game controller, which can satisfy the gaming player's controlling habit and can be disassembled from the game controller or be assembled to the game controller is needed.

### SUMMARY OF THE INVENTION

The present invention is to provide an additional controller on a bottom of game controller which makes a user smoothly operates game and the additional controller is able to detach from the game controller.

An object of the present invention provides an additional controller for engaging with a game controller which has a housing. The additional controller is able to be assembled to the housing, the additional controller comprises a support arm having a first end and a second end. The first end and the second end have different distances from the bottom of the game controller to the first end and the second end respectively. A contact portion is disposed on an outer side of the first end, and the contact portion is configured to be an actuated position. An actuating portion is disposed on an inner side of the first end, and the actuating portion is configured to activate a switch which is disposed inside the housing of the game controller and is located under a guiding hole of the housing. At least one fixing portion is connected to the second end of the support arm, and the fixing portion is able to be mounted on the housing of the game controller by using a tool. When the contact portion is not applied a force, the actuating portion passes though the guiding hole. When the contact portion is applied a force, the support arm is driven to be deformed and the actuating portion activates the switch.

### BRIEF DESCRIPTION OF THE DRAWINGS

The present invention will be apparent to those skilled in the art by reading the following description, with reference to the attached drawings, in which:

FIG. 1 is a schematic view of a top of a game controller with an additional controller;

FIG. 2 is a side view of the game controller of FIG. 1;

FIG. 3 is a bottom view of the game controller of FIG. 1;

FIG. 4 is an exploded view of the game controller of FIG. 1;

FIG. 5 is a schematic view of the additional controller of the game controller;

FIG. 6 is another view of the additional controller of the game controller;

FIG. 7 is a plan view of a portion of the additional controller mounting in the game controller;

FIG. 8 is a cross-sectional view of FIG. 7 along line A-A;

FIG. 9 is an enlarged view of a portion A of FIG. 8;

FIG. 10 is an enlarged view of a portion B of FIG. 9;

### DETAILED DESCRIPTION OF THE PREFERRED EMBODIMENT

The following detailed description is merely exemplary in nature and is not intended to limit the applications and uses disclosed herein. Further, there is no intention to be bound by any theory presented in the preceding background or summary or the following detailed description.

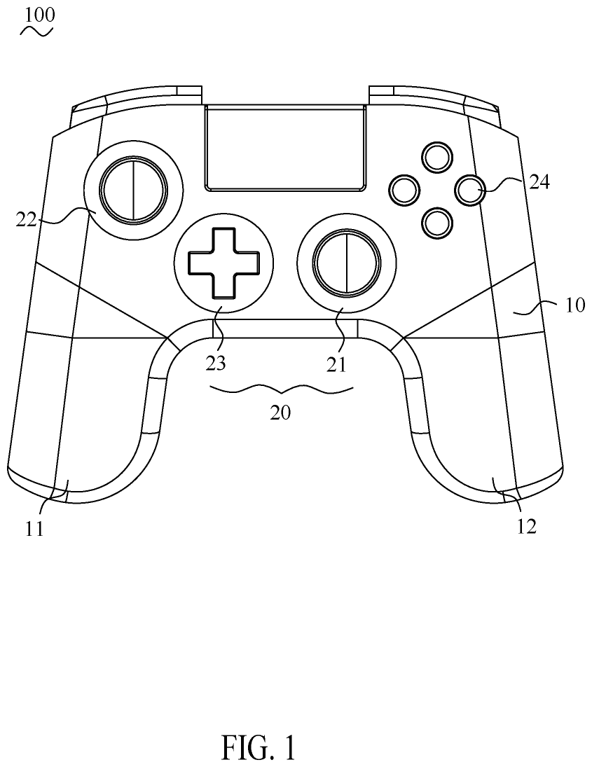

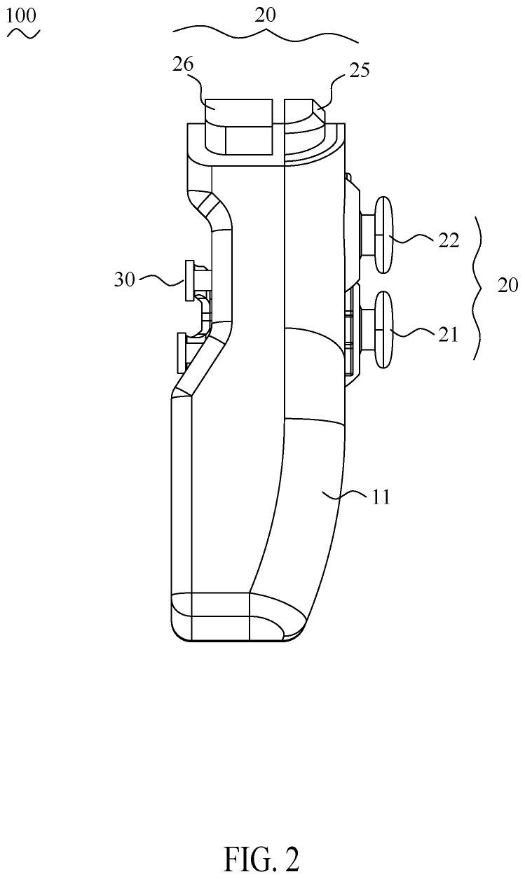

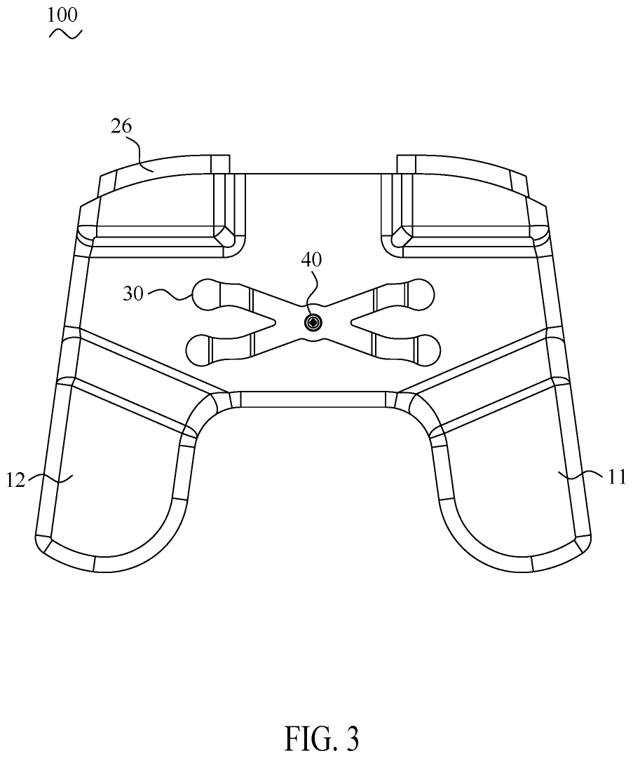

With reference to FIG.1 to FIG. 4, a game controller 100 in accordance with an embodiment of the present invention is shown. The game controller 100 includes a housing 10, a plurality of controlling modules 20, an additional controller 30 and a fixing member 40.

The housing 10 have a left-side handle 11 and a right-side handle 12 which provide a user to grasp of the game controller 100.

The controlling modules 20 comprises a right thumbstick 21, a left thumbstick 22, a directional gamepad 23, four action buttons 24, two bumper buttons 25 and two triggers 26. The right thumbstick 21, the left thumbstick 22, the directional gamepad 23, and the action buttons 24 are located on a top of the game controller 100 which are intended to be operated by the user's left and right thumbs respectively. The bumper buttons 25 and the triggers 26 are located on a front of the game controller 100 which are intended to be operated by the user's index fingers.

With reference to FIGS and FIG.6, the additional controller 30 in accordance with an embodiment of the present invention is shown. The additional controller 30 forms a X-shape with a rotating 90 degrees, wherein a center portion of the additional controller 30 is configured for a mounting location of the game controller 100, and four ends of the additional controller 30 are provided to the user for a pressing position to operate the game controller 100.

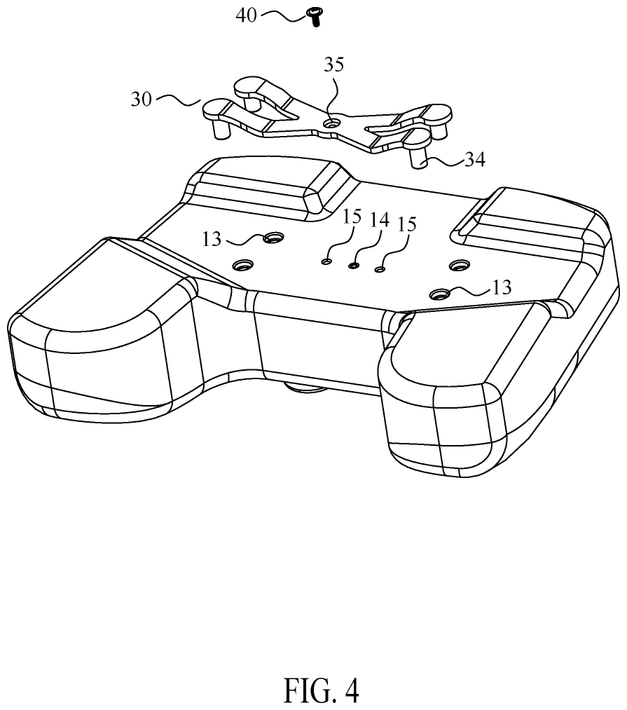

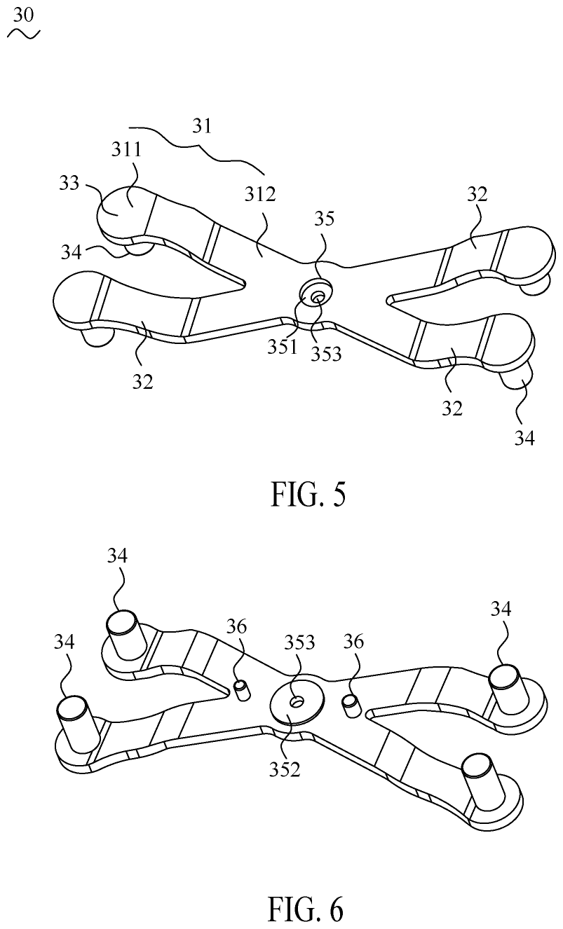

With reference to FIG.4 to FIG. 6, a side of the additional controller 30 is defined as an outer side which faces away from the game controller 100, specifically, the outer side is an operating area which can be applied force by the user. As well, another side of the additional controller 30 is defined as an inner side which faces to the game controller 100.

In the embodiment of the present invention, each of the ends of the additional controller 30 is defined an operating unit 31, each operating unit 31 comprises a first end 311 and a second end 312 with different height. The first end 311 and the bottom of the game controller 100 is formed a first gap therebetween, and the second end 312 and the bottom of the game controller 100 is formed a second gap therebetween. The first gap is bigger than the second gap such that the first end 311 is higher than the second end 312. A support arm 32 connects between the first end 311 and the second end 312. A contact portion 33 is disposed on an outer side of the first end 311 which is configured to be an actuated position by the user. The contact portion 33 is designed as a cambered surface to provide the user a smoothly operation. An actuating portion 34 is disposed on an inner side of the first end 311, wherein the actuating portion 34 is a column extended toward the game controller 100 and is configured to activate a switch 16 inside the game controller 100. When the user applies a force on the contact portion 33, the support arm is driven to be deformed and then the force is transmitted to the actuating portion 34 to activate the switch 16 inside of the game controller 100.

In the embodiment of the present invention, the second end 312 of each of the operating unit 31 connects a fixing portion 35 which is configured to be a fixing position. The user is able to use the fixing member 40 to lock the additional controller 30 on the housing 10 of the game controller 100 by using tools. Specifically, an outer side of the fixing portion 35 forms a circular depression 351, and an inner side of the fixing portion 35 forms a circular bulge 352. A hole 353 is penetrated through the circular depression 351 and the circular bulge 352, wherein a diameter of the hole 353 is less than a diameter of circular depression 351 and a diameter of circular bulge 352.

The fixing portion 35 comprises two positioning posts 36 which is able to help the user to position when the additional controller 30 is mounted on the game controller 100. Each of the positioning posts 36 is located to close the second end 312 of the operating unit 31. Two positioning holes 15 form on the bottom of the housing 10 of the game controller 100. When the user assembles the additional controller 30 to the game controller 100. Each of the positioning posts 36 aligns with each of the positioning holes 15 in first, and then the user uses the fixing member 40 to fasten the additional controller 30 on the housing 10 of the game contro11er 100. Specifically, each of the positioning posts 36 is able to pass through the positioning hole 15. In the embodiment of the present invention, distances between the positioning post 36 and the circular bulge 352 are equal.

In the embodiment of the present invention, the additional controller 30 comprises four operating units 31 which are formed integrally. The second end 312 of each the operating unit 31 stretches inward to intersect to form a X-shape structure, wherein the fixing portion 35 is positioned at an intersection. In some embodiments, the second end 312 of each the operating units 31 would not stretch to intersect to form the X-shape structure, specifically, the second end 312 of each the operating unit 31 forms the fixing portion 35 thereof. In another embodiment, the second ends 312 of two operating unit 31 stretch to each other to intersect and the fixing portion 35 forms in the intersection thereof. The amount of the fixing member 40 corresponds to the amount of the fixing portion 35 for fastening on the game controller 100.

In the embodiment of the present invention, the additional controller 30 has a flexible material or a deformable material such as metal or plastic which has the characteristics of elastic recovery. When the user applies the force to the contact portion 33, the support arm 32 is caused a deformation and makes the support arm 32 biases toward the game controller 100 at the same time, and then, when the user looses the contact portion 33, the support arm 32 is able to return to an original position due to the elastic recovery property. Specifically, the original position means a position of the support arm 32 that the user doesn't apply the force thereon.

With reference to FIG.4, FIG.8 and FIG. 10, an exploded view of the additional controller 30 is mounted in the game controller 100 and a cross-sectional view of the additional controller 30 is mounted in the game controller 10 are shown. The bottom of the housing 10 of the game controller 100 comprises a plurality of guiding holes 13 which penetrate through the housing 10 and each of the guiding hole 13 forms a chamfer edge 131 around thereof on the bottom of the housing 10. The chamfer edges 131 assists the column of the actuating portion 34 more easy to insert in the guiding holes 13, wherein the column of the actuating portion 34 matches a size of the guiding hole 13 of the housing 10 of the game controller 100. A locking hole 14 is form on the bottom of the housing and located between the guiding holes 13, wherein the locking hole 14 is a recess with screw threads. In addition, the positioning holes 15 are disposed near the locking hole 14 and penetrate through the bottom of the housing 10, wherein each of the positioning holes 15 is corresponded to each of the positioning posts 36.

When the user assembles the additional controller 30, the positioning posts 36 of the additional controller 30 align with the positioning hole 15 at first. The actuating portions 34 of the additional controller 30 insert in the guiding holes 13 of the housing 10 respectively, and then each of the actuating portions 34 touches the switch 16 inside the game controller 100. Finally, the fixing member 40 passes through the hole 353 of the additional controller 30 and be locked in the locking hole 14 of the housing 10 of the game controller 100. In the embodiment of the present invention, the fixing member 40 is a screw, specifically, a screw of the fixing member 40 pass through the fixing portion 35 being locked on the housing 10 of the game controller 100 by tools, wherein a screw cap of the fixing member 40 is able to be blocked inside the circular depression 351 and screw threads of the fixing member 40 accord with the screw threads of the locking hole 14.

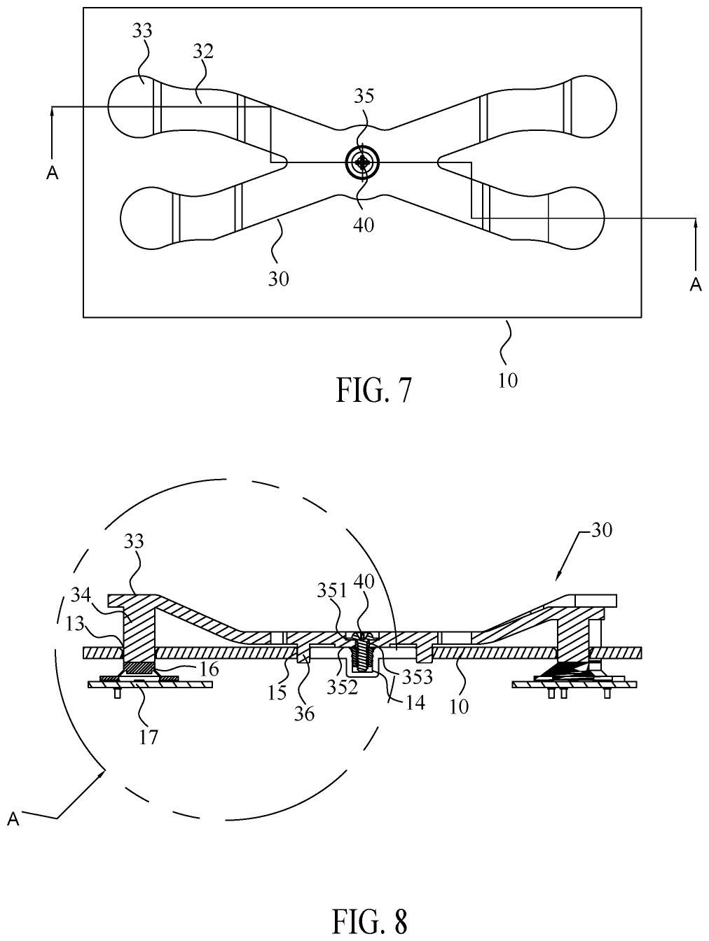

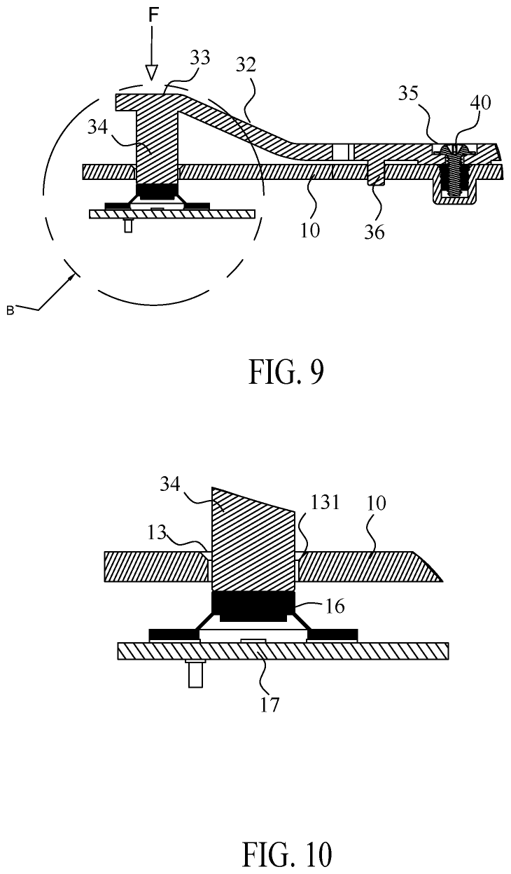

With reference to FIG.7 to FIG.10, a plan view of a portion of the additional controller 30 is mounted on the game controller 100 and a cross-sectional view of the additional controller 30 is mounted on the game controller 10 are shown. The game controller 100 is disposed a plurality of switches 16 inside thereof. The switches 16 are electrically connected to at least one printed circuit board (PCB) 17 wherein each of the switches 16 is a rubber keypad. In the embodiment of the present invention, each the switch 16 is disposed inside the game controller 100 and faces toward each of the guiding hole 13 of the housing 10, and the actuating portion 34 touches a contacting surface of the switch 16 which is similar to the size of the guiding hole 13 and be located beneath an inner surface of the housing 10.

In general, when the additional controller 30 is unused, the actuating portion 34 only touches the switch 16 and not activates the function thereof. When the additional controller 30 is used, the user applies force from F direction to the contact portion 33 and the actuating portion 34 is caused to push the switch 16. Therefore, the function of the switch 16 is activated. After the user finishes the operation, the support arm 32 returns to the original position due to the elastic recovery property of the additional controller 30, the actuating portion 34 also returns to a state which the actuating portion 34 touches the switch 16.

As described above, the additional controller 30 of the game controller 100 includes the operating units 31, each of the operating unit 31 has the support arm 32 which connects the contact portion 33 and the fixing portion 35 with different height at both the ends. When the user applies force to the contact portion 33 which brings the actuating portion 34 to push and activate the switch 16 of the game controller 100. After the user finishes the operation, the support arm 32 returns to the original position and the actuating portion 34 also returns to the state which the actuating portion 34 touches the switch 16. Moreover, the user is able to assemble the additional controller 30 to the game controller 100 by his preference of the operation.

What is claimed is:

1. An additional controller for engaging with a game controller having a housing, the additional controller being able to be assembled to the housing, the additional controller comprising:
a support arm comprising a first end and a second end, the first end and the second end having different distances from a bottom of the game controller to the first end and the second end respectively;
a contact portion disposed on an outer side of the first end, the contact portion being configured to be an actuated position;
an actuating portion disposed on an inner side of the first end, the actuating portion being configured to activate a switch which is disposed inside the housing of the game controller and is located under a guiding hole of the housing; and
at least one fixing portion connected to the second end of the support arm, the fixing portion being able to be mounted on the housing of the game controller by using a tool,
wherein when the contact portion is not applied a force, the actuating portion passes though the guiding hole, when the contact portion is applied a force, the support arm is driven to be deformed and the actuating portion activates the switch.

2. The additional controller as claimed in claim 1, wherein the support arm, the contact portion, the actuating portion and the fixing portion are formed integrally.

3. The additional controller as claimed in claim 1, wherein the fixing portion comprises at least one hole, the housing comprises at least one locking hole.

4. The additional controller as claimed in claim 3, wherein the locking hole has threads screw which makes a screw through the hole being fastened with the locking hole by the tool.

5. The additional controller as claimed in claim 1, wherein the actuating portion comprises a column which matches a size of the guiding hole, the column inserts in the guiding hole.

6. The additional controller as claimed in claim 1, wherein the guiding hole has a chamfer edge.

7. The additional controller as claimed in claim 1, wherein the support arm is formed from a flexible material or a deformable material.

8. The additional controller as claimed in claim 1, wherein the fixing portion comprises at least one positioning post which is located near the second end.

9. The additional controller as claimed in claim 8, wherein at least one positioning hole is formed on the housing, when the additional controller is mounted on the game controller, the positioning post passes through the positioning hole.

10. The additional controller as claimed in claim 1, wherein the support arm, the contact portion, and the actuating portion are together defined as an operating unit, the fixing portion connects a plurality of the operating units.

11. The additional controller as claimed in claim 10, wherein the operating units are intersected to formed an intersection, the fixing portion is disposed on the intersection.

12. An additional controller of a game controller:
at least one fixing portion fastened to a housing of the game controller;
at least one support arm extended from the fixing portion;
an actuating portion disposed on an inner surface of a free end portion of the support arm;
wherein when the contact portion is not applied a force, the actuating portion passes though the housing;
wherein when the contact portion is applied a force, the support arm is driven to be deformed and the actuating portion activates a switch inside the housing.

13. The additional controller as claimed in claim 12, wherein the support arm, the actuating portion and the fixing portion are formed integrally.

14. The additional controller as claimed in claim 13, wherein when the contact portion is not applied the force, the actuating portion contacts the switch.

15. The additional controller as claimed in claim 13, wherein the actuating portion passes through a guiding hole formed on the housing, a chamfer edge is formed surround the guiding hole.

16. The additional controller as claimed in claim 13, wherein the fixing portion comprises at least one positioning post positioned in a positioning hole of the housing.

17. The additional controller as claimed in claim 12, wherein each of opposite sides of the fixing portion has two support arms.

18. An additional controller of a game controller:
at least one fixing portion fastened to a housing of the game controller, the fixing portion having a flat inner surface near a surface of the game controller;
at least one support arm extended from the fixing portion and extended far away from the surface of the game controller;
an actuating portion extended from an inner surface of a free end portion of the support arm;
wherein when the actuating portion is not applied a force, the actuating portion passes though the housing and aligns with a switch inside the housing;
wherein when the actuating portion is applied a force, the support arm is driven to be deformed and the actuating portion activates the switch.

19. The additional controller as claimed in claim 18, wherein the actuating portion passes through a guiding hole formed on the housing, a chamfer edge is formed surround the guiding hole.

20. The additional controller as claimed in claim 18, wherein the fixing portion comprises at least one positioning post positioned in a positioning hole of the housing.
